(19) United States
(12) Patent Application Publication
(10) Pub. No.: US 2012/0066349 A1
(43) Pub. Date: Mar. 15, 2012

(54) METHOD AND SYSTEM USING TWO OR MORE STORAGE DEVICES FOR AUTHENTICATING MULTIPLE USERS FOR A SINGLE TRANSACTION

(76) Inventors: Douglas H. Trotter, Baltimore, MD (US); Darren Lacey, Parkville, MD (US)

(21) Appl. No.: 13/206,009

(22) Filed: Aug. 9, 2011

Related U.S. Application Data
(60) Provisional application No. 61/374,082, filed on Aug. 16, 2010.

(51) Int. Cl. G06F 15/16

(52) U.S. Cl. 709/219

(57) ABSTRACT

A method for using multiple storage devices for authenticating multiple users in regard to a single transaction is described. The method includes receiving data at a server, the data indicative of a first user attempting to access the server through a first interface operable with a first storage device, receiving data at the server, the data indicative of a second user, having an association with the first user, attempting to access the server through a second interface operable with a second storage device, producing, at the server, a hash value from a combination of the data indicative of the first user and the data indicative of the second user, communicating, upon creation of the hash value, transaction counter values from each of the storage devices to the server, initiating transaction based counters, at the server, based on the communicated counter values, performing a transaction within the server based on data retrieved from at least the first storage device, and iterating the transaction based counters upon completion of the transaction.

### CROSS-REFERENCE TO RELATED APPLICATIONS

This application claims the benefit of Provisional Patent Application Ser. No. 61/374,082, filed Aug. 16, 2010, and titled “METHOD AND SYSTEM USING TWO OR MORE STORAGE DEVICES FOR AUTHENTICATING MULTIPLE USERS FOR A SINGLE TRANSACTION”, the contents of which are hereby incorporated by reference in their entirety.

### BACKGROUND

The disclosure relates generally to information distribution including information protection and control and, more particularly, to methods and systems that use two or more storage devices for authenticating multiple users for a single transaction, where the transaction is typically internet-based. Embodiments relate to secure transmission, exchange, and storage of data, as well as, authentication of users and transactions, and digital signing and tracking of transactions. As used herein, the term “transaction” refers to sharing of information and related work (e.g., database updating). Such sharing and related work may be viewed as a unit, which is sometimes referred to herein as a transaction.

Sharing information across multiple networks for use in many different contexts presents numerous challenges. For example, certain types of information cannot simply be uploaded or downloaded from one computer to another across a network. Rather, certain types of information may be stored on a disk (i.e., a transportable media) and physically carried from one computer to another. When information on the disk is updated, information stored on a network database or on numerous network databases also should be updated. Ensuring that all appropriate information is up-to-date across a network, particularly when transportable media is utilized, can be a significant challenge.

Also, in some contexts, laws or policies impose strict confidentiality and authentication obligations in connection with enabling sharing of such information. The confidentiality obligations can, for example, pertain to particular types or segments of information. For example, in the medical context, doctors and health care providers generally desire a reliable and secure approach for assembling comprehensive patient records from distributed sources. The sources may include multiple provider facilities, such as clinics and hospitals, each of which maintains their own patient database, or similar storage device. Each facility database may change each time the provider is visited by a particular patient. Outright sharing of the data across a network, however, can be difficult due to the security obligations imposed by the Health Insurance Portability and Accountability Act (HIPPA).

Smart cards and other portable storage devices are frequently used to authenticate users for transactions, whether nearby, or through the Internet. Known smartcard technology, however, generally has limited memory storage which constrains the amount of data that can be stored on the smartcard. For example, the known smartcard does not have sufficient memory to store large records. In addition, with such known smartcards, privacy is attempted to be maintained by encrypting an identifier that is associated with the holder of the smartcard. Once access to a file is granted to a user, the access to the information contained in file may be without limit. The user can, for example, modify the file, copy the file, display the file, print the file, e-mail the file, and/or transfer the file to another information system via a network. Also, after the file is distributed outside of the immediate control of the patient, security for the distributed file is left to the discretion of those who obtain a copy.

### BRIEF DESCRIPTION

In one aspect, a method for using multiple storage devices for authenticating multiple users in regard to a single transaction is provided. The method includes receiving data at a server, the data indicative of a first user attempting to access the server through a first interface operable with a first storage device, receiving data at the server, the data indicative of a second user, having an association with the first user, attempting to access the server through a second interface operable with a second storage device, producing, at the server, a hash value from a combination of the data indicative of the first user and the data indicative of the second user, communicating, upon creation of the hash value, transaction counter values from each of the storage devices to the server, initiating transaction based counters, at the server, based on the communicated counter values, performing a transaction within the server based on data retrieved from at least the first storage device, and iterating the transaction based counters upon completion of the transaction.

In another aspect, a system for authenticating multiple users in regard to a single transaction is provided. The system includes a first user device operable to interface with a first storage device associated with a first user, a second user device operable to interface with a second storage device associated with a second user, and a server communicatively coupled to the first user device and the second user device. The server is programmed to receive data from the first storage device via the first user device indicative of a first user attempting to access the server, receive data from the second storage device via the second user device indicative of a second user attempting to access the server, produce a hash value from a combination of the data received from the first storage device and the second storage device, receive transaction counter values from each of the storage devices via the respective user devices, initiate transaction based counters based on the received counter values, perform a transaction based on further data retrieved from at least the first storage device, and iterate the transaction based counters upon completion of the transaction.

In still another aspect, a method for authenticating users to a restricted transaction is provided. The method includes substantially simultaneously sending, via separate user interfaces, information from two separate storage devices to a server, the information sent from the first storage device associated with a first class of user, the information sent from the second storage device associated with a second class of user, producing, at the server, a combined hash value based on the information received from the storage devices, and based on the hash value, exchanging data between the server and the storage devices relating to a transaction initiated through one of the user interfaces.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1 is a functional block diagram of a system for using two or more storage devices to authenticate multiple users with respect to a single transaction.

FIG. 2 is a front view of a smart card according to one embodiment.

FIG. 3 is a front view of another embodiment of a smart card operable with a secure exchange system.

FIG. 4 is a back view of the secure card of FIG. 3, showing a USB connector embedded therein.

FIG. 5 is another front view of the secure card of FIG. 3 with the USB connector extended from the secure card.

FIG. 6 is a diagram illustrating a data hierarchy for the memory associated with the secure card of FIGS. 2, 3, 4, and 5.

FIG. 7 is a representation a secure card/secure exchange solution with several possible components represented.

FIG. 8 is a flowchart illustrating a method for using two or more storage devices to authenticate multiple users with respect to a single transaction.

### DETAILED DESCRIPTION

As mentioned above, smart cards and other portable storage devices are frequently used to authenticate users for transactions, whether nearby, or through the Internet. The described embodiments are directed to a method and associated system for authenticating multiple parties to a single electronic transaction. In embodiments, such transactions may conducted via a stand alone system, but typically will be conducted via a wide area network (e.g., Internet) connection. As described further herein, electronic storage devices (with or without partition memory), including cards protected with “smart” chips, can be used for authentication.

The described methods are especially useful where there is a potential for fraud by one or both parties to the transaction. Each party to the transaction possesses a one of the above mentioned memory devices, sometimes referred to generically as a “smart card”, but which includes any storage device, usually mobile. Each smart card includes an encrypted volume with essential information about the cardholder stored thereon, as well as an identifying number (serial number) and a counter initiation value. In some embodiments the card may include other identifying information (e.g. address, phone number) and/or information from a digital wallet (e.g. blood type, organ donor status).

In the method, the content of the card can only be useful when in the presence of another card from a different class of users. The term “presence” refers to a methodology where data from a first card can only be accessed when data from a second smart card is also available to a processing function. For example, a preferred embodiment would include different smart cards for patients and medical providers. Data from such cards is coupled in order to initiate and complete a transaction. In the medical context, and in one example, patient cards could only be utilized when in the presence of a provider card with the connection brokered by a server connection.

Each authenticating card (the patient smart card and the provider smart card) is accessed (plugged in, swiped, or scanned) or otherwise linked to a single or multiple linked computing device(s) substantially simultaneously in order to produce a combined hash value with input from both cards. In one embodiment, the combined hash value is generated upon coupling of data from the two smartcards and this hash value, in one embodiment, includes location codes and time stamps. An encrypted serial number or counter from each smart card is also communicated through secure means to a transaction server. The transaction server is capable, in one embodiment, of initiating a transaction and iterating a server-specific counter for accounts related to each card. In an embodiment, one or more of the smart cards may be configured with partition memory.

In some embodiments, information stored on the surface or in an encrypted volume of the smart card is used to authenticate visually and/or through questions to the individuals. Other authentication mechanisms are utilized in other embodiments including password, tokens, one-time passwords, pins, and biometrics.

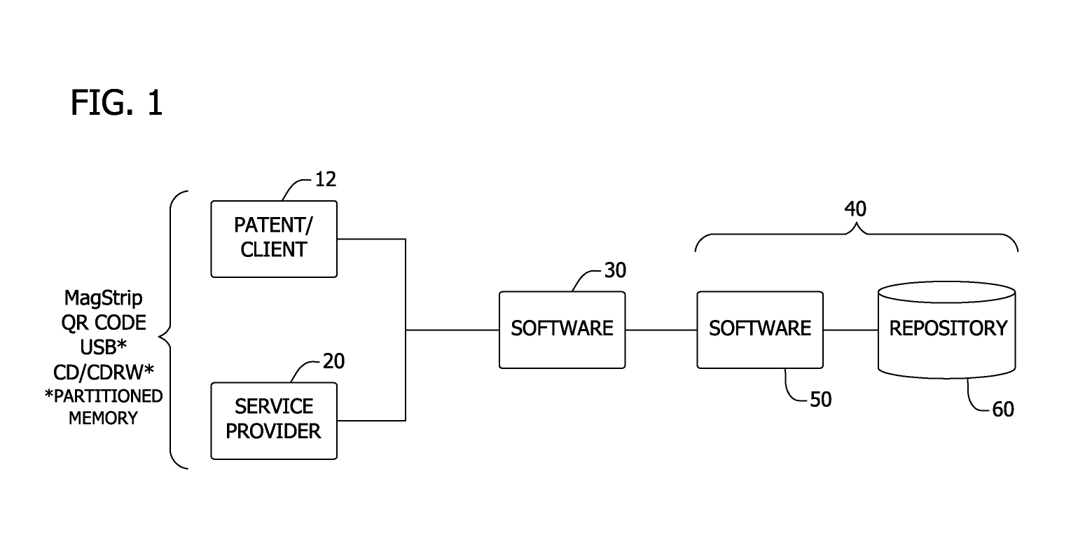

As shown in FIG. 1, transactions can be completely automated or involve input by users during a card-initiated session. Referring specifically to FIG. 1, a system 10 for using two or more storage devices for authenticating multiple users for a single transaction is functionally illustrated. The two storage devices include a patient/client smartcard 10 and a service provider smartcard 20. Smartcards 12 and 20 may incorporate one or more of a magnetic strip, a USB interface, a quick response code or other type of barcode, and a CDRW interface. Certain of these “memories” may be partitioned.

At the beginning of a transaction data from cards 12 and 20 is gathered by a “front end” system 30 which includes a software function which is also utilized to provide passwords, authenticate the smartcards 12 and 20 to a back end system 40, as well as request claim and transaction numbers and/or serial numbers from the back end system 40. The software function is typically hosted by a provider's computer network (e.g., system 30) which is capable of secure communications with the remotely located back end system 40. The back end system 40 includes a software package 50 enabling communications with the “front end” software function 30 as well as storage 60.

The back end system 40 is operable for retrieving private keys and counters, creating hash values, storing the hash values in transaction registers, creating unique transactions and returning claim authorizations to the front end system 30. Upon a return of a claim authorization, the front end system 30 communicates the claim to the provider for submission.

In certain embodiments, transactions require both smart cards (patient/client card 12 and service provider card 20) to remain in place for the duration of the transaction in order to produce the hash values related to initiation and completion of each transaction. In some embodiments the smart cards may be writable via the front end system 30, while in other embodiments the card is written only upon creation and all changes and logs to the account are managed by the transaction server within the back end system 40.

The combination of combined hash values, multi-factor authentication, encrypted communications, distinct classes of cards, counter values, serial numbers, session and transaction duration logs and continuous presence creates a highly secure and workable system. For example, embodiments involving patient interactions would allow access to clinical portals, personal health records or pharmaceutical interactions. Smart cards can be read securely on a kiosk which would include in stored memory one of the validating cards. The described embodiments could be used in combination with card swipe technologies on credit cards, driver licenses and other identification cards.

Security is provided through a robust distributed data collection and analysis framework. Counter patterns are analyzed using pattern recognition and anomalous access identified. Summarizing, an information system is provided for secure permission-based authentication to a multi-party transaction. This information system also provides unique transaction identification for a multi-party transaction as well as providing a third party outside multi-party transaction and verification that a transaction did occur and that all parties were involved in the transaction.

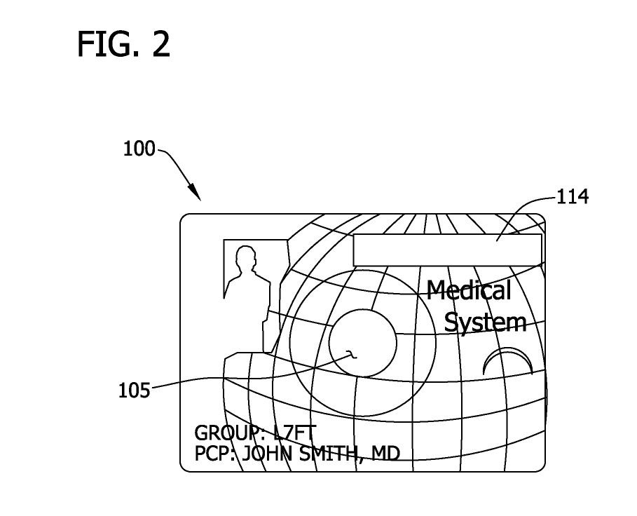

FIG. 2 is a front view and back view, respectively, of a data card 100, which is sometimes referred to herein as a smart card. Data card 100 is one embodiment of the smart cards 12 and 20 referred to with respect to FIG. 1. In the illustrated embodiment, card 100 is substantially the same size as a standard credit card or identification card and may be carried in a standard wallet. Data card 100 includes a wallet-sized CDRom and may also include one or both of a magnetic strip or a bar code thereon. The data card 100 is a business-card size rectangular optical disk including a front section (FIG. 2) bearing promotional information, and rear section (not shown) bearing the functional features of the optical disk. The disk is formed from plastic with optical data-recording tracks formed by encased perforated gold foil as is typical of optical discs, the perforations being optically readable from the back. An aperture 105 is provided for a reader spindle.

Data card 100 is flexible and is capable of bearing a magnetic strip 114 or bar code. The magnetic strip 114 contains magnetically encoded patient ID information that can be read by “swiped” current credit card or debit card verification readers at any location and transmitted to a server for authentication. The optically readable portion contains, for example, up to 50 Mb of digital information encrypted per permission-based content control software (to be described). In addition to the magnetic strip 114, the card 100 may include a paper strip or a specially coated strip (not shown) like a regular credit card to allow for a patient to sign.

As an addition or alternative to the magnetic strip 114, the disk 100 may be provided with a two- or three-dimensional barcode (not shown) containing the same information. In this case, a two- or three-dimensional barcode can be applied by an image transfer printed by modified large-format digital printer. In one embodiment, the transfer is applied by a selective release transfer process as set forth in U.S. patent application Ser. No. 11/879,744 entitled DIGITAL TRANSFER METHOD FOR PRINTING ON A TARGET SURFACE. In another embodiment, the information can be directly placed on the target surface utilizing an inkjet printing process at 1440 dpi by 1440 dpi or 1440 dpi by 2880 dpi.

Most general purpose computers and similar devices contain an optical data disk reader (Compact Disk—CD or Digital Versatile Disk—DVD) and/or USB port, and can thereby read and write information to/from a removable optical disk or USB token card. The removable optical disks or USB tokens can be written, read, re-written or erased many times. Business-card shaped CD's or USB tokens are relatively new but commonplace.

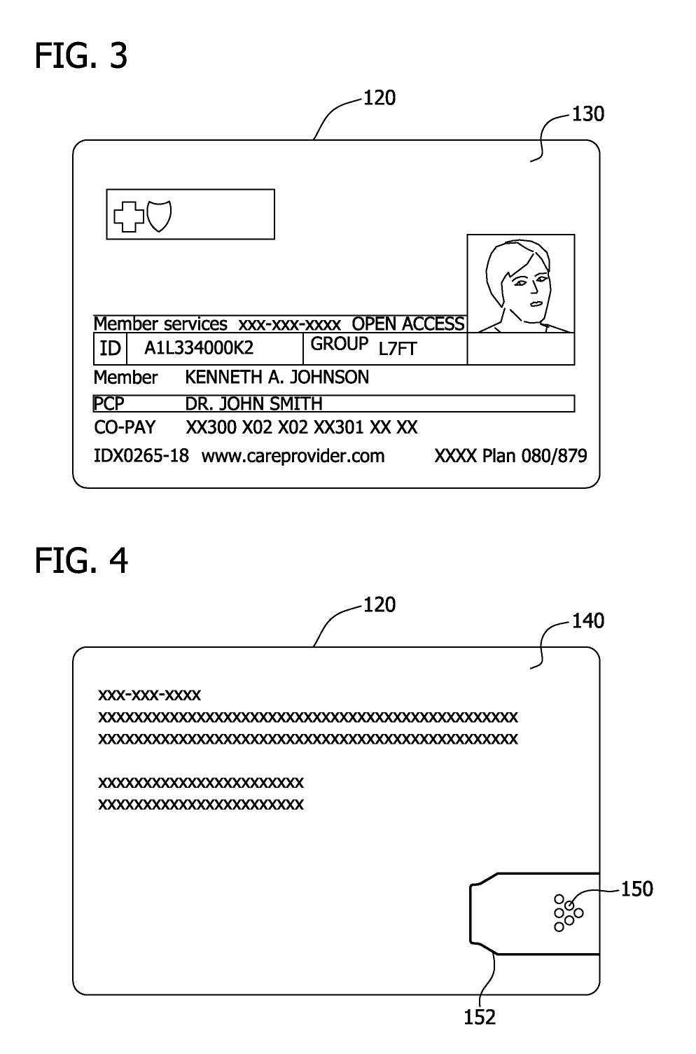

FIGS. 3, 4, and 5 are, respectively, a front view, a rear view, and a USB connector extended view of a trusted data card 120, which is substantially the same size as a standard credit card, business card, or identification card. Data card 120 is one embodiment of the smart cards 12 and 20 referred to with respect to FIG. 1. Though the description herein utilizes card 120 as an example, it should be noted that any device capable of communicating with a computer and containing memory sufficient to hold the data desired could be utilized, including, but not limited to, cell phones, PDAs, optical storage devices, and other portable devices that contain such memory.

FIG. 3 illustrates the front side 130 of the card 120 which in various embodiments includes one or more of a graphic representation of an image of the holder, participant, and corporate image identification or logo. The front side 130 may also include descriptive information of holder, participant, company, for example, a name, a surname, a date of birth, a gender, a social security number, an enrollment identification number, contact information and marital status. In addition, the front side 130 may include the rendering of a two dimensional or a three dimensional bar code or any other representation of identification that can be read or recognized by any form of reading or recognition device. Other information or graphics that may be used to identify the card to an individual or company or any other party may be included on the front side of the card 120 as space permits.

FIG. 4 illustrates the back side 140 of the card which may include any of the information described in the preceding paragraph, in addition to any additional information that the card supplier wants printed on the card, including but not limited to, instructions, graphics, controls and advertising collateral. The USB connector 150 housed in an alcove 152 formed in the card 120 which is fabricated to store the connector 150 flush with the overall structure of the card 120.

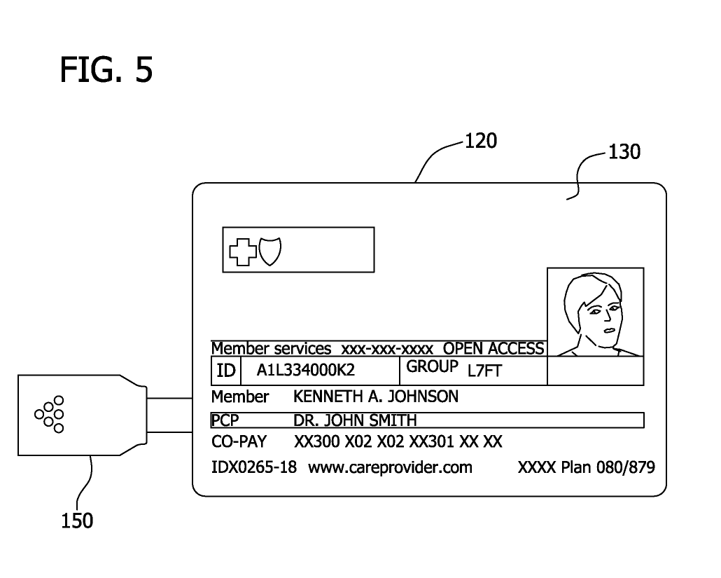

FIG. 5 is an illustration of the front side 130 of card 120 with the USB connector 150 extended therefrom. Referring generally to secure card 120, data is stored in memory embedded in the card and is accessible via the USB connector 150. The USB connector 150 is stored simply by sliding the connector 150 into the alcove 152 in the card 120. The USB connector 150 slides flush with the casing defined by alcove 152 to maintain a traditional card form factor. When the contents of the memory within the card 120 are to be accessed or updated, the USB connector 150 is pulled out and can be subsequently plugged into any conventional computer USB port. In one embodiment, the USB connector 150 provides access to an embedded flex-film PC card with on-board memory of various sizes thereon. Through the described embodiments, secure card 120 includes a capability to store data in a resident memory that is embedded within card 120.

As with card 100 described above, card 120 may also include a substantially flat front side and at least a portion of a substantially flat rear side that accommodates multiple forms of rendering thereon, which is described above. The images that may be placed on the card 130 may include, but are not limited to, one or more two dimensional bar codes, one or more three dimensional bar codes, personal information, one or more photographs, either in color or black and white, one or more signature blocks, printed instructions, and logos.

All data written to the secure card 120 and its supporting secure exchange system is encrypted and digitally signed, and the retrieval thereof, as described above, is managed via authentication of users and permission based roles that are implemented by the card interacting with a remote authentication and roles server. The secure exchange system includes services rendered from a central location which in various embodiments includes, but is not limited to an enforcement agent that enforces the security policy look-up table in accordance with the identity of each user that attempts to access the record data, a routing agent that allows for the routing of information to designated endpoints, and an authentication methodology, that provides for password, challenge-response, and/or bio-metric authentication of an individual based on data entered into the system in association with secure card 120.

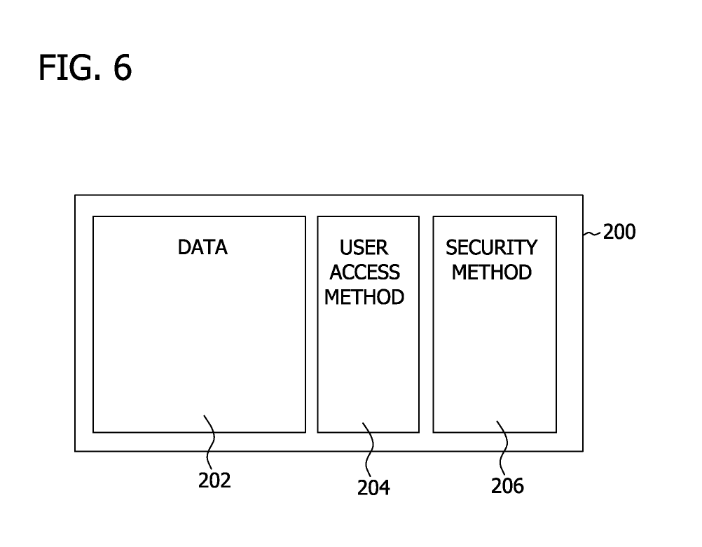

FIG. 6 is a view of the logical structure of security, management and data that may be stored within a memory 200 of the smart cards 12 and 20 (shown in FIG. 1). FIG. 6 is but one embodiment of the logical components that could be constructed and represented on cards 12 and 20, however, any particular embodiment may include the addition or removal of certain memory components.

Data section 202 represents data that is typically stored on the cards 12 and 20. This data can represent anything that can be stored electronically in any format. The data can be stored in any format within a database, or a file structure or any other manner of organizing of the data. The following description describes one embodiment of the data storage capability and should not be construed to be limiting. For example, access to the data can be controlled by way of rules, roles, and access rights, amongst others that can be initiated by way of physical or logical security and authentication. The data can be encrypted or left in an original format. The data can be compressed using multiple variations of compression algorithms. The data can be set up to be viewed in a generic form or structure, or via an application or viewer. The data can be digitally signed and certified.

A user access component 204 of the memory 200 represents the application component that provides a user or application an interface to the data or logic stored within the cards 12 and 20. Depending on the application of the cards 12 and 20, the data or any other logic stored on the card or remote environment as part of the secure exchange, or external to the secure exchange as further described herein, is accessed. However, the access to this area will be achieved in the following manner, in one embodiment. For example, access may be achieved through a web site, a thin client, an application, any editor or file viewer resident on the cards 12 and 20 giving access to the data or logic. Access may also be achieved through a web site, a thin client, an application, any editor or file viewer resident on any other device which can provide access to the data or logic. Access may also be achieved by using any application to execute any specific logic stored on the cards 12 and 20. This methodology can be built up in any language including, Java, C++, any tool in the Visual Studio pack, or any other language. A web site, a thin client, an application, any editor or file viewer resident within a secure exchange server, described below, may also provide access to the data stored within the cards 12 and 20.

Security method 206 represents the security component or enforcement agent of the cards 12 and 20. The security component of the cards 12 and 20 controls the overall behavior of the device under any condition. More specifically, the security component of the cards 12 and 20 is activated once the card is activated and accessed, for example, by placing the USB connector 150 in the USB port of a computer. The security component, which may also be referred to herein as an enforcement agent has the following non-limiting functions. Specifically, the security component acts as an authentication agent, to ensure that the user(s) are who they say they are, identify the data that describes any person, application, logic, or any other means by which an attempt could be made to access the data stored within the cards 12 and 20 outside of the roles allocated by the card holder as further explained herein. The data stored within the cards 12 and 20 includes any information, byte, anatomical particle, graphical file, compressed file or any other data stored on the device that is requested by someone attempting to access the data 202 maintained on the cards 12 and 20.

More specifically, the security component 206 determines access rights to “What data” by “Who (as identified by other data)” and allows or blocks, the rights associated to any access to any content or application on the device. These rights can include, but are not limited to the open, save, update, edit, create, delete, rename, move, add, append, concatenate, comment, compile and/or browse functions of anything on the card. The security component interacts with a roles server to provide authentication, and any other service or server required to enforce any role or restriction of access that has been defined. The security component also serves to provide the encryption of the information stored on the cards 12 and 20 and digitally certify any activity associated with the secure card.

Keeping with the medical records example used throughout this document, the patient's partial medical records are stored on the cards 12 and 20, and depending upon user preference, some or all of the patient's complete record is remotely stored on a central server. In some instances the user may elect to only store data on their secure card. However, for archiving, backup, or other reasons, the card holder may elect to store some or all of their records at the server. The portion of the patient's medical records is limited only by the amount of memory on the cards 12 and 20 and by the decisions made by the patient. When the patient presents his or her secure card 12, the provider's office verifies the patient against a photograph of the card holder printed on the card 12, swipes the card to authenticate the user (and preferably verifies the patient's signature), and then inserts the card in an ordinary desktop computer containing a USB port. The desktop computer then asks for a password, and the user (patient) will furnish their password. The process is repeated for card 20, specifically, the desktop computer then asks for a password associated with another user (nurse, physician, resident, or other user) who also provides their password, initiating the role allocation process described throughout this document. In embodiments, secure cards 12 and 20 are utilized with separate user interfaces.

When the passwords are entered into the desktop computer, in certain embodiments twice for confirmation, the desktop computer sends an electronic “key” to a secure server. If the password has been recorded on the server, the key will be recognized and the secure server will respond by sending another, matching electronic key back to the desktop. When the exchange of matching keys is completed, the user will receive information that is decrypted at the individual user's permitted level of access. The verification process is completed in a matter of a few seconds. It should be apparent that the two card approach offers multiple security measures: 1) passwords assigned locally according to local policy that must be known to gain access; 2) central server-based security where the passwords must be recognized according to pre-determined rules; 3) a photograph and/or a signature block for visual authentication. In one alternative embodiment, the smart cards 12 and 20 may also include a magnetic strip imprinted with a unique identity key to provide an additional level of security.

Information is “locked” at some levels of access and is open at others, based on the user's classification and assigned user-rights. As described by further example below, some users are allowed to read only parts of a record. Some users will be allowed to read all parts of a record. Some users are allowed to make changes to a file. Some are allowed to print and disseminate information. Newly entered information is encrypted and recorded to the cards 12 and 20 on the spot and may also be sent to a server for permanent storage. When a user reads, changes, or adds to a record, the transaction is recorded and it becomes part of an electronic audit trail on the permanent record. Thus, if a user gives his or her password to an unauthorized party, that person's entry to the system will be recorded and monitored.

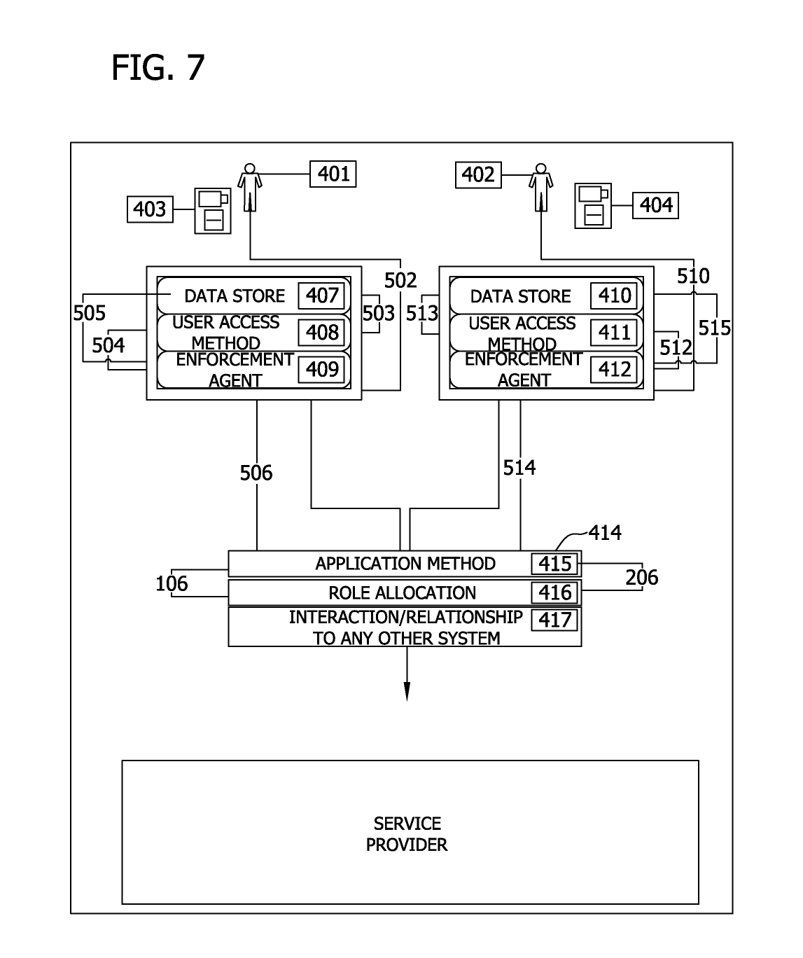

FIG. 7 is a diagram illustrating one embodiment of a secure exchange/secure card solution with several possible components of the secure exchange system represented. It should be noted that any particular deployment, may or may not include all the aspects described with respect to FIG. 7.

A first card holder 401 is the person who has been allocated a secure card for any reason or application. The secure card provides a secure, portable mechanism for transporting data. The first card holder 401 can assume any role and use the card for the transportation of any data. The ability to access the data and the role that the person plays when the card is accessed is defined by User Access Method 408, Enforcement Agent 409, Authentication Method 415, Role allocation 416, and user two, the second card holder 402. The first card holder 401 may interface with numerous role-players and require the card to be accessed by numerous devices to complete a transaction.

With respect to a second card holder 402, there are a number of transactions that require the role of a second (or third) card holder. Specifically, there are a number of scenarios where second card holder 402 will have rights associated with them to participate or fulfill types of transactions. However these roles will always be managed by the Authentication Method 415, and the Role Server 416.

The secure cards 403 and 404 are two instances of the physical device described in FIGS. 2-5. As further described, secure card 403 includes the Data Store 407, User Access Method 408, and Enforcement Agent 409 and represents a secure method for the transportation of information. The access to the information on the card 403, the Data Store 407, is managed and controlled by, User Access Method 408, Enforcement Agent 409, the Authentication server 415, and the Roles Server 416.

A second secure card 404 is utilized in a number of transactions, but not all transactions require the role of second secure card 404. The second secure card 404 is similar to the secure card 403. The substantially simultaneous pairing of two or more secure cards 403 and 404 can be used to activate specific types of transactions as described further herein. These transactions include, but are not limited to roles allocated by the Roles Server 416 to the Enforcement Agent 409 on card 403 and the enforcement agent 412 on card 404. Secure card 403 is utilized to issue specific rights to second card holder 402, for either card 403 or card 404. Another transaction includes the pairing of cards 403 and 404, together with the roles allocated by the Roles Server 416, which may result in a transaction to an external system using any gateway service represented as integration service 417, or initiate any other service within the trusted exchange environment 414.

The pairing of the first secure card 403 and the second secure card 404, together with the roles allocated by the Roles Server 416, allows either first card holder 401, and/or second card holder 402 to effect one, some, or all of the following functions: open, save, update, edit, create, delete, rename, move, add, append, concatenate, comment, compile and/or browse functions of anything on the cards 403 and 404.

Together, the various components make up the secure cards 403. Those components include the content (data store 407) which is accessed via user access method 408, however all access, encryption, roles and restrictions are managed by the Enforcement Agent 409 with reference to the Authentication server 415, and the Roles Server 416.

With regard to Data Storage system 407, the secure card 403 is able to store anything that can be converted to a format that can be stored on a memory device. First card holder 401 can, by inserting the USB connector into any device that can execute the User Access Method 408, get access to data stored on the data store 407. The level of access and the role that first card holder 401 assumes is governed by the enforcement agent 409.

With regard to the user access method 408, the content of the card is made available to a user via the user access method 408. Method 408 can be built using any coding language, methodology and logic. The presentation of anything stored on the card 403, as well as the ability to initiate any other transaction, is accomplished via the User Access Method 408. The functionality provided by user access method 408 can be provided via any method that can be developed using any coding method.

Access to any aspect of the card is controlled and managed by way of an enforcement agent 409. The enforcement agent 409 is, amongst other functions, the encryption method, the authentication methodology, and security for all aspects of the content of the secure card 403. The Enforcement Agent 409, depending on what the system is being used for, will make use of any methodology, cryptology, and security system to authenticate a user or application. Based on the level or authentication required to access any component of the solution, the enforcement agent 409 will limit access to the data store 407 and enable features and functions in the user access method 408. The enforcement agent 409 passes user credentials to the authentication server 415 to authenticate the user if connected to the secure exchange and to the roles server 416, for specific roles to be passed to the enforcement agent 409, which are filtered down to the user access method 408 and the data store 407.

With regard to data storage system 410, the second secure card 404 is able to store anything that can be converted to a format that can be stored on a memory device. As mentioned above, under certain conditions, one, two or multiple cards can form part of the solution. The second, third or multiple cards may or may not have stored information on them, and depending on the application of the solution it may or may not be accessed by second card holder 402, after the relevant authorization by the second enforcement agent 412, and using the appropriate method defined in the second user access method 411.

The content of the secure cards is made available to a user via the user access method 411, which is used when the multi card solution is being deployed. In the normal application of this solution, the functionality, and methods activated on second secure card 404, by way of the second user access method 411, is controlled by the second enforcement agent 412.

The second enforcement agent 412 controls and manages access to any aspect of the card 404. The second enforcement agent 412 is, amongst other functions, the encryption method, the authentication methodology and security for all aspects of the content. The second enforcement agent 412 secures all aspects of the Secure card 404. When a multi card solution is deployed, the roles that second, third, and fourth, etc. secure cards provide in the solution are managed by the second enforcement agent 412, after identifying the second card user 402.

The second enforcement agent 412 authenticates the second user 402 locally and also by calling the authentication method 415, then identifying that users role, on the role server 416. After the authentication process has been executed, and the user's role defined, the second user 402, can access data on the second card 404, the Data Store 410, or have access to some, or all data on the first secure card 403, which is stored in data store 407. In this scenario, second enforcement agent 412 will ship credentials to the Authentication server 415, the Roles Server 416, and the Enforcement Agent 409.

Trusted exchange 414 is a service to authenticate all users and applications of the solution, host and enforce the roles identified and described with respect to FIG. 7, provide the ability to queue messages when necessary, provide the means to integrate to third party or other systems, and provide an audit capability. Components of the Trusted Exchange 414 interact with all parts of the overall solution.

With regard to authentication method 415, any aspect of the trusted solution is managed and executed by the authentication method 415. This role can be fulfilled by any technology executing LDAP type services installed in the Trusted Exchange. More specifically, the authentication method 415 includes an authentication server that interacts with the total solution in different ways and at different times. For example, when first card user 401 inputs the first secure card 403 into any system, the enforcement agent 409 applies access rights to those user credentials. The enforcement agent 409 may, under certain conditions, initiate a request to the authentication server 415 to get additional rights to engage the user access method 408 and /or the data store 407. The authentication server 415 may also, under certain conditions, accept a request from a second secure card 404. These requests could take place concurrently, or singularly, and under specific conditions, the rights issued to second card user 402, using second secure card 404, could depend on the identity of the first card user 401, and their secure card 403.

The role allocation server 416 manages the roles executed by any component of the solution. Once first card user 401 and secure card 403 have been identified and authenticated, and the enforcement agent 409 has activated, a request many be issued to the authentication method 415 to authenticate the first card user and first secure card 403 into the Trusted Exchange 414. Once this transaction has taken place, the credentials will be passed to the role allocation server 416, which will issue the relevant role to the first card user 401, which could include some or all of these functions open, save, update, edit, create, delete, rename, move, add, append, concatenate, comment, compile and/or browse functions of anything on the card.

There are instances where first card user 401 and second card user 402 will be executing a joint or mutual transaction that will require different roles being issued by the role allocation server 416 to secure card 403 and secure card 404. In addition, there are instances where with the appropriate authentication and role allocation being issued to the second secure card 404, and thus second card user 402, will be given access to the data on secure card 403. Depending on the authentication and role allocation process, the second card user 402 may be issued some or all of these functions open, save, update, edit, create, delete, rename, move, add, append, concatenate, comment, compile and/or browse functions of anything on the first secure card 403.

With regard to integration with an external system, integration service component 417 of the Trusted Exchange 414 allows the trusted solution to send transactions to and receive transactions from systems external to the trusted solution, in a secure and managed way. The first card holder 401 independently, or in combination with the second card holder 402, can initiate certain transactions. In this scenario a call will be generated by the integration service 417 to an external system to initiate transactions with that external system. The transaction will typically be initiated by first card user 401 inserting first secure card 403 into a device, being authenticated by the enforcement agent 409, and then being authenticated into the trusted exchange by the Authentication server 415, and an appropriate role being issued by the role allocation server 416. Concurrently, or independently, the second card user 402 inserts the second secure card 404 into an appropriate device, and second card user 402 is authenticated by the enforcement agent 412 for the second secure card 404. The second card user 402 is then authenticated into the trusted exchange 414 by the enforcement agent 412 transacting with the authentication method 415 in the Trusted Exchange 414 via the Authentication server, and an appropriate role being issued with respect to the first card holder 401 and the first secure card 403 by the role allocation server 416. The matching of the two appropriately authenticated cards and users, will allow for a unique set of transactions which could include any type of transaction to an external system such as a financial institution of clearing agent.

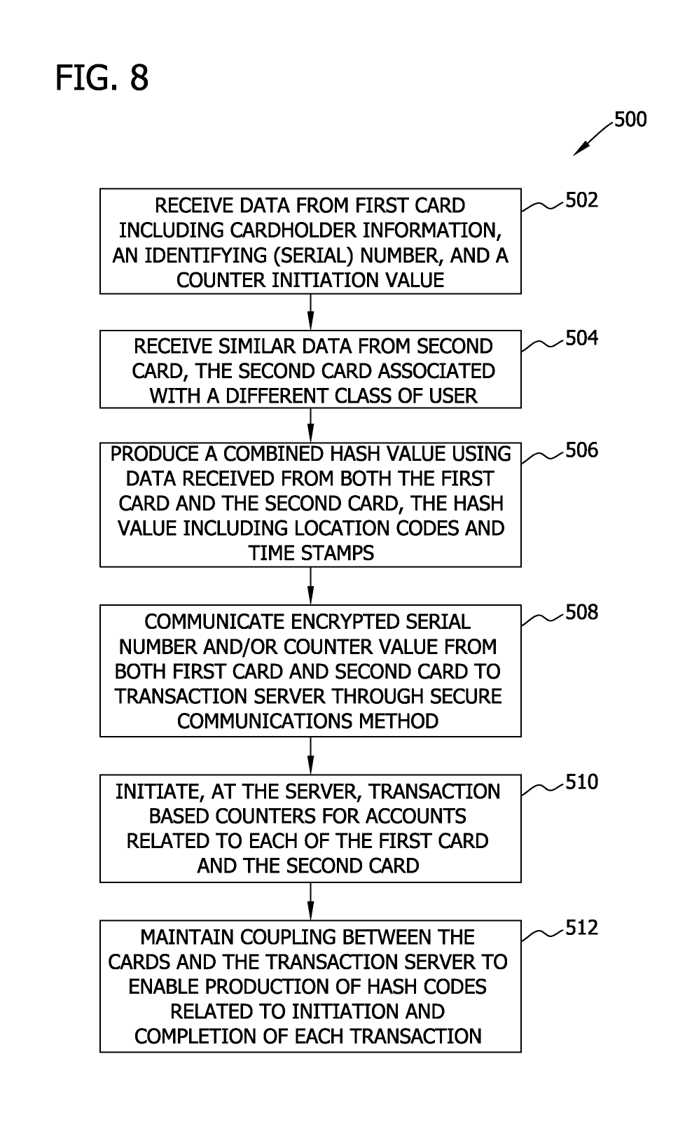

FIG. 8 is a flowchart 500 further illustrating the processes associated with the trusted card/secure exchange system described herein. Data from the first card is received 502 and includes cardholder information, an identifying (serial) number, and a counter initiation value. Similar data is received 504 from the second card, which is associated with a different class of user. In embodiments, the cards are accessed substantially simultaneously through two separate interfaces.

Once a system, such as a server system, receives the data from the first card and the second card, a combined hash value is produced 506 using data received from each of the cards. In embodiments, the combined hash value includes location codes and time stamps. Encrypted serial numbers and/or counter values are communicated 508 from both the first card and the second card to a transaction server using a secure communications method. Transaction based counters at the transaction server are initiated 510 for accounts related to each of the first card and the second card. In embodiments, all transactions require that both cards remain communicatively coupled 512 with the transaction server for the duration of the transaction period such that hash values are produced that are related to initiation and completion of each transaction.

Each authenticating card (the patient smart card and the provider smart card) is accessed (plugged in, swiped, or scanned) or otherwise linked to a single or multiple linked computing device(s) substantially simultaneously in order to produce a combined hash value with input from both cards. In one embodiment, the combined hash value is generated upon coupling of data from the two smartcards and this hash value, in one embodiment, includes location codes and time stamps. An encrypted serial number or counter from each smart card is also communicated through secure means to a transaction server. The transaction server is capable, in one embodiment, of initiating a transaction and iterating a server-specific counter for accounts related to each card. In an embodiment, one or more of the smart cards may be configured with partition memory.

The described embodiments, and flowchart 500 illustrate a method for using multiple storage devices for authenticating multiple users in regard to a single transaction. Such a method includes receiving data at a server, where the data is indicative of a first user attempting to access the server through a first interface operable with a first storage device. Similarly, additional data is received at the server that is indicative of a second user, having an association with the first user, attempting to access the server through a second interface operable with a second storage device. Such data may include user information and an identifying number associated with the respective storage device. Further data may be indicative that the first storage device and the second storage device are associated with different classes of user, for example, and as described herein, the first user might be a medical patient and the second user a medical provider.

The server next produces a hash value from a combination of the data indicative of the first user and the data indicative of the second user and upon completion of the hash value creation, queries the storages device such that the server receives transaction counter values from each of the storage devices. Hash values, in one embodiment, include one or more of location codes for the user devices and time stamps. Receipt of the transaction counter values causes transaction based counters to be initiated at the server, which based on the communicated transaction counter values.

The server continues by performing a transaction within the server based on data retrieved from at least the first storage device, and iterates the transaction based counters upon completion of the transaction. The server then updates, based on completion of a transaction, the transaction counter value within each storage device. To perform a transaction within the server based on data retrieved from the first storage device, in one embodiment, includes verifying that the second storage device is communicatively coupled to the server. In other embodiments, performing a transaction within the server based on data retrieved from at least the first storage device includes producing hash values related to one or more of initiation of each transaction, completion of each transaction, and data retrieved from the second storage device.

In various embodiments, receiving data includes receiving at least one of data entered manually through the interface based on visual data printed on the storage device, answers to one or more questions entered into the user interface in response to a prompt from the server, a password entered into the user interface, a personal identification number entered into the user interface, a token sent from the storage device, and biometric data received via the user interface.

This written description uses examples to disclose various embodiments, which include the best mode, to enable any person skilled in the art to practice those embodiments, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for using multiple storage devices for authenticating multiple users in regard to a single transaction, said method comprising:
receiving data at a server, the data indicative of a first user attempting to access the server through a first interface operable with a first storage device;
receiving data at the server, the data indicative of a second user, having an association with the first user, attempting to access the server through a second interface operable with a second storage device;
producing, at the server, a hash value from a combination of the data indicative of the first user and the data indicative of the second user;
communicating, upon creation of the hash value, transaction counter values from each of the storage devices to the server;
initiating transaction based counters, at the server, based on the communicated counter values;
performing a transaction within the server based on data retrieved from at least the first storage device; and
iterating the transaction based counters upon completion of the transaction.

2. The method according to claim 1 wherein receiving data at a server comprises receiving user information and an identifying number associated with the respective storage device.

3. The method according to claim 1 wherein the first storage device and the second storage device are associated with different classes of user.

4. The method according to claim 1 wherein producing a hash value comprises including at least one of location codes for the user devices and time stamps in the hash value.

5. The method according to claim 1 wherein:
receiving the data indicative of a first user includes receiving data relating to the first user as a medical patient; and
receiving the data indicative of a second user includes receiving data relating to the second user as a medical provider.

6. The method according to claim 1 wherein receiving data comprises receiving at least one of data entered manually through the interface based on visual data printed on the storage device, answers to one or more questions entered into the user interface in response to a prompt from the server, a password entered into the user interface, a personal identification number entered into the user interface, a token sent from the storage device, and biometric data received via the user interface.

7. The method according to claim 1 further comprising updating, based on completion of a transaction and via instructions generated by the server, the transaction counter value within each storage device.

8. The method according to claim 1 wherein performing a transaction within the server based on data retrieved from at least the first storage device comprises verifying that the second storage device is communicatively coupled to the server.

9. The method according to claim 1 wherein performing a transaction within the server based on data retrieved from at least the first storage device comprises producing hash values related to initiation of each transaction, completion of each transaction, and data retrieved from the second storage device.

10. A system for authenticating multiple users in regard to a single transaction, said method comprising:
a first user device operable to interface with a first storage device associated with a first user;
a second user device operable to interface with a second storage device associated with a second user; and
a server communicatively coupled to said first user device and said second user device, said server programmed to:
receive data from the first storage device via said first user device indicative of a first user attempting to access said server;
receive data from the second storage device via said second user device indicative of a second user attempting to access said server;
produce a hash value from a combination of the data received from the first storage device and the second storage device;
receive transaction counter values from each of the storage devices via the respective said user devices;
initiate transaction based counters based on the received counter values;
perform a transaction based on further data retrieved from at least the first storage device; and
iterate the transaction based counters upon completion of the transaction.

11. The system according to claim 10 wherein:
the data received from the first storage device comprises information relating to the first user and an identifying number associated with the first storage device; and
the data received from the second storage device comprises information relating to the second user and an identifying number associated with the second storage device.

12. The system according to claim 10 wherein data received from the first storage device and data received from the second storage device are indicative that the first user and the second user are in different user classes.

13. The system according to claim 10 wherein to produce a hash value from a combination of the data, said server is programmed to include at least one of location codes for the user devices and time stamps in the hash value.

14. The system according to claim 10 wherein said user devices are operable for at least one of:
manual entry of data through a user interface based on visual data printed on the respective said storage device;
manual entry of answers to one or more questions through a user interface based on a prompt from said server;
manual entry of a password through a user interface based on a prompt from said server;
manual entry of a personal identification number through a user interface based on a prompt from said server; and
entry of biometric data through a user interface based on a prompt from said server.

15. The system according to claim 10 wherein upon completion of a transaction, said server is programmed to update the transaction counter value within each of the first storage device and the second storage device.

16. The system according to claim 10 wherein prior to performing a transaction based on further data retrieved from at least the first storage device, said server is programmed to verify that the second storage device is still communicatively coupled thereto.

17. The system according to claim 10 wherein to perform a transaction based on further data retrieved from at least the first storage device, said server is programmed to produce hash values related to initiation of each transaction, completion of each transaction, and data retrieved from the second storage device.

18. The system according to claim 10 wherein said user device comprises an interface related to the storage device, the interface comprising at least one of a magnetic strip reader, a data port, a scanner, a keyboard, a touch screen, a biometric device, and an optical reader.

19. A method for authenticating users to a restricted transaction, said method comprising:
substantially simultaneously sending, via separate user interfaces, information from two separate storage devices to a server, the information sent from the first storage device associated with a first class of user, the information sent from the second storage device associated with a second class of user;
producing, at the server, a combined hash value based on the information received from the storage devices; and
based on the hash value, exchanging data between the server and the storage devices relating to a transaction initiated through one of the user interfaces.

20. The method according to claim 19 further comprising verifying that one of the users is associated with a class of user that has authority for initiating the transaction.
